(19) United States
(12) Patent Application Publication
(10) Pub. No.: US 2018/0374027 A1
(43) Pub. Date: Dec. 27, 2018

(54) INTERACTIVE DASHBOARD INTERFACE FOR DYNAMIC VISUALIZATION OF VIRTUAL TEAMS AND FITMENT

(71) Applicant: Jadav Manirao Sampath, Bangalore (IN)

(72) Inventor: Jadav Manirao Sampath, Bangalore (IN)

(21) Appl. No.: 15/983,329

(22) Filed: May 18, 2018

Related U.S. Application Data
(63) Continuation-in-part of application No. 14/616,912, filed on Feb. 9, 2015, now abandoned.

(30) Foreign Application Priority Data
May 23, 2014 (IN) 2563/CHE/2014

(51) Int. Cl. G06Q 10/06; G06Q 10/10

(52) U.S. Cl. CPC G06Q 10/063114; G06Q 10/1053; G06Q 10/06398; G06Q 10/063118

(57) ABSTRACT

A computer implemented system displays virtual teams on an interactive dashboard interface. The virtual teams and competency analysis of individuals displayed on the interactive dashboard interface are based on evaluation and assessment of character attributes of individuals based on a self rater and multi rater ratings which are obtained based on answers to specific questions provided by an individual and his/her peers respectively. The system comprises a user device display unit that displays the interactive dashboard interface. The interface communicates with a processing unit configured to receive self-rater and multi rater ratings and is further configured to compute competency analysis of individuals. The processing unit may be configured to dynamically display the competency analysis of a virtual team put together by a user using the interface and is further enabled to change the competency analysis in near real time when the user changes the configuration of the virtual team.

### CROSS REFERENCE TO RELATED APPLICATIONS

This application is a continuation in part of U.S. patent application Ser. No. 14/616,912 that claims priority from Indian patent application bearing application number 2563/CHE/2014 filed on May 23, 2014 and it is incorporated by reference herein along with all other references cited therein.

Certain portions and images of this patent document contain material, which is subject to copyright protection. The copyright owner has no objection to the reproduction of such content as long as it is reproduced as a part of this patent document, but otherwise reserves all copyrights whatsoever.

### TECHNICAL FIELD

The present invention relates to an interactive dashboard interface that interactively displays results of an assessment and evaluation system and method. The dashboard interface displays the effectiveness of a virtual team comprising of potential team members based on their attributes and more particularly offering dynamic visualization of competency analysis of virtual teams and individual fitment on a dashboard interface.

### BACKGROUND

In an ever-evolving competitive world, organizations have come to realize the importance of hiring the right kind of human resource and the criticality of having a team of people with complementary competencies work together. Today the success or failure of any project absolutely depends upon bringing together the right set of people with skill sets that enhance the overall effectiveness of a team.

Some organizations prefer to assess a person or a group based on a prescribed personality test, while others put the individuals to test with an assorted range of puzzles, IQ tests and so on. These organizations are of the impression that the prescribed tests and assessments will help identify the weak or strong areas of a person's mindset and once they have identified it, they may prefer to train/develop a person in the area which they think the person is lacking. However, these tests are mostly one-dimensional and any assessment tools that utilize these apply the same assessment on every individual irrespective of different personalities, thinking patterns, right or left brain functioning etc. Not only is the human brain a remarkable organ, every individual is different from one another and his/her thought patterns will vary in most aspects when compared to anyone else.

There are also a significant amount of human attributes and characteristics and a mere personality or an IQ test will just unravel a very tiny portion of an individual's qualities and strengths. Most assessment tools do not offer any visualization interface and most senior management personnel are left guessing based on paper/e-reports generated by these assessment tools. CEOs, project managers and the like have to solely rely on their instinct when hiring someone or when building a team for a particular project. Even if they have one of such assessment tools available for evaluating a person, the tool only provides some insight into the individual's strengths and weaknesses and does not analyze to what extent the individual fits into the team dynamics and organization culture.

In an existing method an assessment tool makes an attempt to group people based on their IQs and emotional quotient but does not address whether any individual's character attributes or behavior patterns are a right fit for the team/group or not.

In another existing method, techniques for monitoring neurophysiologic indicators of the members of a team while performing one or more collaborative tasks is disclosed. However, this method does not perform a thorough multi-rater or 360-degree review and also does not compare the ratings given by different respondent categories. It also does not provide suggestions and triggers to learn specific modules or information.

In light of the above, there appears to be a need for a thorough and comprehensive method and system to evaluate, assess and enhance human resource potential and provide decision makers with a tool/interface to dynamically visualize the fitment of an individual in a specific team and to put together a virtual team and predict its efficiency and effectiveness even before it is functional.

### SUMMARY OF ILLUSTRATIVE EMBODIMENTS

Accordingly, the invention provides a computer implemented system to interactively display virtual teams on an interactive dashboard interface. The virtual teams and competency analysis of individuals displayed on the interactive dashboard interface are based on evaluation and assessment of character attributes of individuals based on a self rater and multi rater ratings which are obtained based on answers to specific questions provided by an individual and his/her peers respectively. The system comprises a user device display unit that displays the interactive dashboard interface. The interface is in communication with a processing unit that is configured to receive self-rater and multi rater ratings and is further configured to compute competency analysis of individuals. The processing unit may be configured to dynamically display the competency analysis of a virtual team put together by a user using the interface and is further enabled to change the competency analysis in near real time when the user changes the configuration of the virtual team.

Accordingly, the invention provides a method to display virtual teams and their corresponding competency analysis in an interactive dashboard display based on self ratings received from individuals and multi ratings received from his/her peers for a specific set of questions. The interface receives input from users to change the configuration of the virtual team being displayed and sends the change in configuration to the processing unit. The processing unit dynamically updates the competency analysis and displays to the user in near real time.

### BRIEF DESCRIPTION OF THE DRAWINGS

FIG. 1 is a block diagram depicting the components in an evaluation, assessment and interactive display system, according to embodiments as disclosed herein.

FIG. 2 illustrates a computing environment implementing the application, according to embodiments disclosed herein.

FIG. 3 is a flow diagram depicting the mode of operation in evaluation, assessment and interactive display, according to embodiments as disclosed herein.

FIG. 4 is a snapshot illustrating the multiple functionalities of the interactive dashboard interface.

FIG. 5 is a snapshot illustrating description of strong and weak character attributes for an individual based on self rater and multi rater ratings.

FIG. 6 is a snapshot illustrating depiction of virtual teams in the interactive dashboard interface.

FIG. 7 is a block diagram depicting a virtual team building in the interactive dashboard interface.

### DETAILED DESCRIPTION

The embodiments herein and the various features and advantageous details thereof are explained more fully with reference to the non-limiting embodiments that are illustrated in the accompanying drawings and/or detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The present disclosure describes illustrative embodiments of an interactive dashboard interface, system, method and environment for dynamic and interactive creation and display of virtual teams. The virtual team may include at least two members chosen from a larger group based on the members' self and peer ratings. The ratings are based on answers to a series of questions chosen from a predefined questionnaire.

For the purposes of this disclosure an individual's peers shall mean people that the individual may interact with or have a relationship with in the individual's professional, personal or general environment or any person who may be in a position to rate the individual with respect to one or more character attributes.

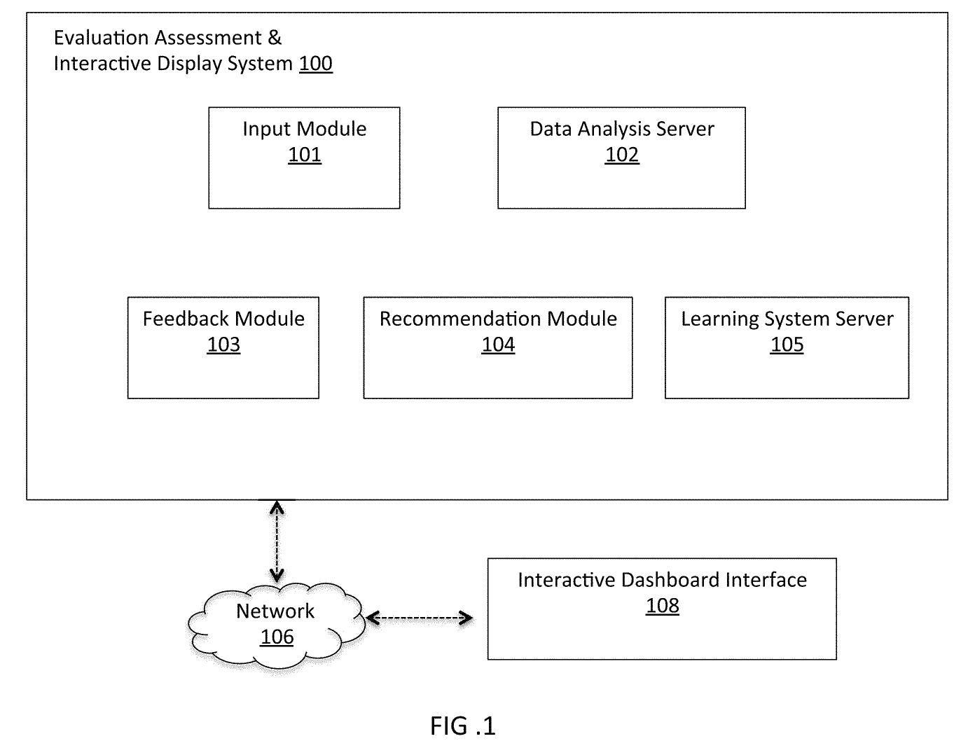

In an exemplary implementation, FIG. 1 is a block diagram depicting the components in an evaluation, assessment and interactive display system. As depicted in FIG. 1 the evaluation and assessment system 100 comprises of an input module 101, data analysis server 102, feedback module 103, recommendation module 104, learning system server 105 and an interactive dashboard interface 108. The system 100 is connected to a suitable network 106 such as internet. The evaluation assessment system 100 can also be run offline if the user has installed the system.

In an embodiment the evaluation and assessment system 100 can be run on any device that is connected to a suitable network 106. The device can be a handheld device such as a smart phone, tablet, Personal Digital Assistant (PDA) and the like or the device can be embedded in a portable computer (Laptop and the like)

The input module 101 receives data from one or more users using the evaluation and assessment system 100. This data is received when users respond to questions chosen from a preset questionnaire or while performing one or more collaborative tasks assigned by the evaluation and assessment system 100.

The data analysis server 102 comprises a database, which has a list of pre-determined questions and surveys to be answered by the user. The questions are pre-determined and are listed in a specific order (e.g. chronologically). The questionnaire may be based on a pre-determined model, the pre-determined model comprising one or more test dimensions, each of the one or more test dimensions comprising one or more key areas, each of the one or more key areas having one or more behaviors, each of the one or more behaviors having one or more practices, each of the one or more practices being assigned a pre-determined level, wherein each question of the questionnaire is associated with a corresponding practice. In an exemplary embodiment the test dimensions and key areas may be based on a SWOT (Strength Weakness Opportunity Threat) analysis. Under each of the key areas one or more behaviors (based on individual's answers) may be assessed including but not limited to prioritization, being organized, openness, initiative, influence, expression, aspiration, acceptance, conviction, people involvement, task involvement, context sensitivity, etc. Each of the behaviors may be associated with corresponding practice such as execution, engagement, discipline etc. The practices may be assigned a pre-determined level on which the individual may assess himself/herself (self rater scale) or the individual's peer may assess him/her (multi rater scale).

Different stages of evaluation require a unique set of questions to be asked. The questionnaire is based on an exhaustive list of permutations and combinations required for obtaining specific in depth understanding about the individual's character attributes.

The feedback module 103 is configured to process and conduct a detailed analysis of the responses gathered from the individual (self rater) and from his/her peers (multi rater). The self rater and multi rater scales may either be the same scale for assessing answers from both the individual and the peers or may be different scales. The feedback module 103 is configured to gather all the ratings and provide a detailed scoring for the individual based on a comparison of the self rater and multi rater ratings. Various known statistical and comparison techniques may be used to calculate competency analysis and scores.

The feedback module 103 may be configured to assess the competency of a virtual team of at least two individuals put together by a user wherein the individuals of the virtual team have taken the assessment and their individual character attributes are rated and scores are already available. Such competency analysis may be based on a match of the individuals' relative strengths and weaknesses. For example if one individual is weak in context sensitivity while another individual is strong in the same, then they may be a good match for a virtual team. In another exemplary embodiment, the feedback module 103, in response to a user/project requirement, may be configured to virtually put together at least two individuals to form an effective virtual team based on their scores for each character attribute. The feedback module 103 may provide instantaneous change in overall competency rating of the virtual team when a user replaces one individual with another in the virtual team.

The recommendation module 104 is configured to send individual character attribute ratings and competency analysis as assessed by the feedback module to the interactive dashboard interface 108. The recommendation module 104 may be further configured to send virtual team recommendations to be displayed on the interactive dashboard interface 108. The interactive dashboard interface 108 may allow a user to interact by replacing one individual of a virtual team with another individual to see the change in competency in near real time. The user may interact with the interface 108 by dragging and dropping an additional member to the virtual team or drag and replace one member with another to witness the change in competency analysis of the resultant virtual team. In an exemplary embodiment the user may interact with the interface 108 via voice commands or gestures when the device displaying the interface 108 possess such capabilities.

The learning system server 105 is configured to identify at least one learning lesson for each particular attribute that an individual is weak in. The learning system server 105 may be further configured to ask additional questions based on earlier assessment of the individual to customize lessons for the individual. The learning system server 105 may be in communication with the interface 108 to display appropriate lessons and information or corresponding hyperlinks to the individuals in order to improve their competency with respect to specific character attributes.

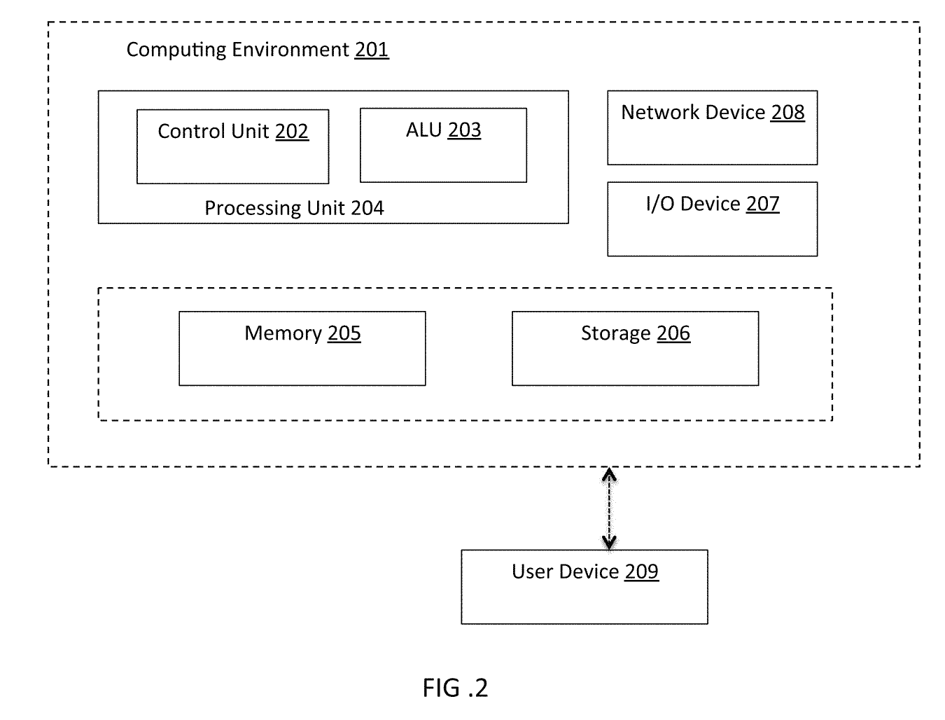

FIG. 2 illustrates a computing environment 201 and network architecture implementing the assessment system. As depicted the computing environment comprises at least one processing unit 204 that is equipped with a control unit 202 and an Arithmetic Logic Unit (ALU) 203, a memory unit 205, a storage unit 206, at least one networking device 208 and at least one input output (I/O) device 207. In a preferred embodiment, the computing environment comprises of a user device 209 with a display unit, which is in communication (wired or wireless) with the other components of the computing environment in order to permit a user to interact with the computing environment.

The processing unit 204 is responsible for processing the instructions of the algorithm. The processing unit 204 receives commands from the control unit 202 in order to perform its processing. Further any logical and arithmetic operations involved in the execution of the instructions are computed with the help of the ALU 203. The overall computing environment can be composed of multiple homogeneous and/or heterogeneous cores, multiple CPUs of different kinds, special media and other accelerators.

The algorithm comprising of instructions and codes required for the implementation are stored in either the memory unit 205 or the storage 206 or both. At the time of execution, the instructions may be fetched from the corresponding memory and/or storage and executed by the processing unit. In case of any hardware implementation various networking devices 208 or eternal I/O 207 devices may be connected to support the communication, interaction and overall implementation.

The processing unit 204 may be configured to receive rating by a first individual for multiple questions from a questionnaire based on a pre-determined self-rater and compare it against the ratings received from the individual's peers based on a multi rater. The processing unit 204 may be further configured to provide competency analysis scores for each individual who has completed the assessment. The processing unit 204 may be further configured to provide at least one recommendation regarding competency analysis of an at least two member virtual team, based on the self rater and the multi rater ratings of the members of the virtual team. The processing unit may be configured to be in communication with the user device displaying the interactive dashboard interface 108 and provide near real time update in the competency analysis based on user requests and actions.

The user device 209 may be configured to enable an individual to provide self ratings (self rater scale) or the individual's peer to provide ratings for the individual (multi rater scale). The user device 209 may be further configured to display on its display unit the interactive dashboard interface 108 and may have interactive capabilities such as microphone, touch interface, voice command interface, gesture recognition camera and sensors to enable any user to provide inputs and interact with the interface 108 and receive corresponding output from the processing unit in near real time. For example a user may visualize a virtual team on the interactive dashboard display and may replace an individual of the virtual team with another individual to visualize the change in competency analysis of the virtual team. Alternatively, the user may add another individual to the virtual team to visualize the impact on the competency of the virtual team.

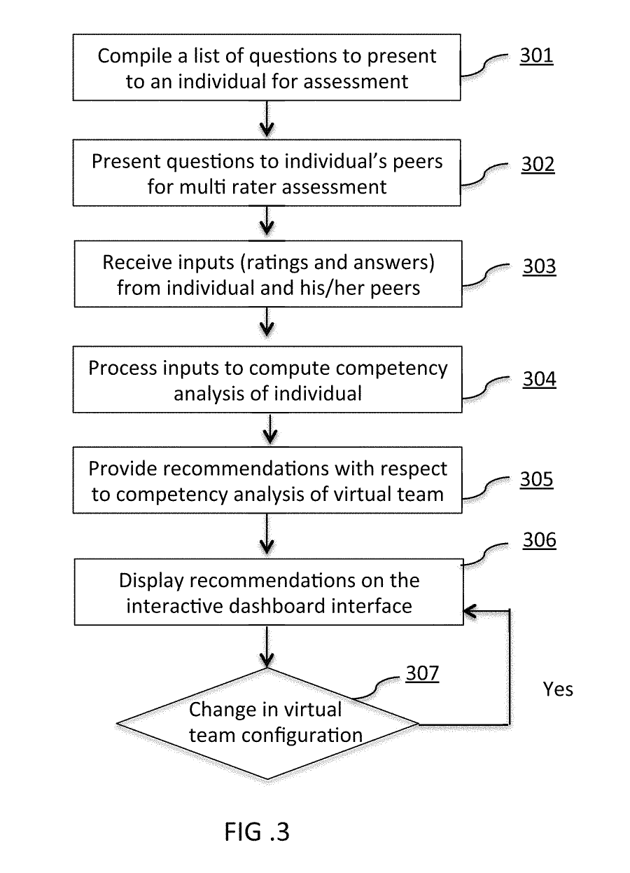

FIG. 3 is a flow diagram depicting the mode and method of operation in the evaluation and assessment, according to embodiments as disclosed herein. As depicted in the flow diagram 300, initially at step 301 a list of questions are compiled and presented to an individual for self rater assessment. The questions are also presented to the individual's peers for the individual's multi rater assessment 302.

The questions being presented may be chosen from a preset questionnaire. The questionnaire may be based on a pre-determined model, the pre-determined model comprising one or more test dimensions, each of the one or more test dimensions comprising one or more key areas, each of the one or more key areas having one or more behaviors, each of the one or more behaviors having one or more practices, each of the one or more practices being assigned a pre-determined level, wherein each question of the questionnaire is associated with a corresponding practice. In an exemplary embodiment the test dimensions and key areas may be based on a SWOT (Strength Weakness Opportunity Threat) analysis. Under each of the key areas one or more behaviors (based on individual's answers) may be assessed including but not limited to prioritization, being organized, openness, initiative, influence, expression, aspiration, acceptance, conviction, people involvement, task involvement, context sensitivity, etc. Each of the behaviors may be associated with corresponding practice such as execution, engagement, discipline etc. The practices may be assigned a pre-determined level on which the individual may assess himself/herself (self rater scale) or the individual's peer may assess him/her (multi rater scale).

At step 303 inputs in the form of answers and ratings to questions are received from the individual and his/her peers. The inputs include answers to questions. Further at step 304 the inputs received are processed by the processing unit 204 to compute the competency analysis of an individual who has completed the assessment i.e. whose self rater and multi rater ratings have been received.

At step 305 the processing unit 204 provides recommendation with respect to the competency analysis of a virtual team that the processing unit puts together either based on a user input where the user selects and combines multiple individuals in a team or the processor automatically generates the virtual team based on a user's requirements. At step 306 the competency analysis of individuals and virtual team is displayed in the interactive dashboard interface 108.

At step 307 the processing unit receives a user input with respect to change in the construction of the virtual team (adding a member, replacing a member, removing a member etc.) through the interactive dashboard interface 108. At step 308 the processing unit updates the competency analysis of the modified virtual team dynamically in real time assuming that the new individual brought in as an addition or replacement has also gone through the assessment.

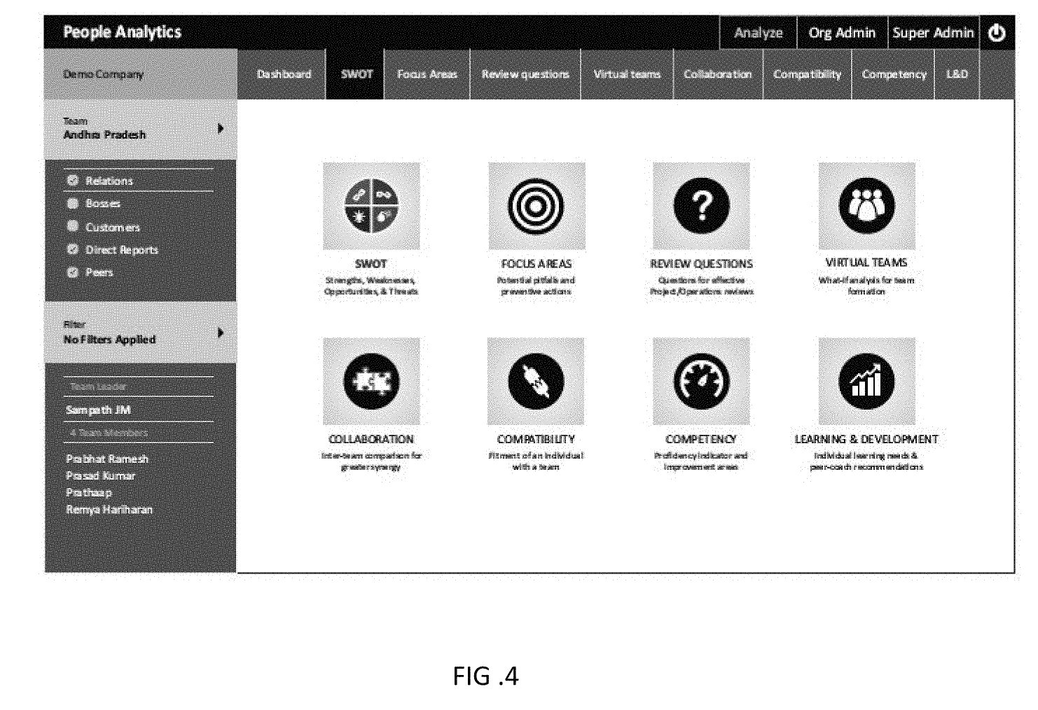

FIG. 4 is an illustrative depiction of a snapshot of the multiple functionalities of the interactive dashboard interface. The multiple functionalities may include the specific detailed analysis visualization such as SWOT, specific focus area analysis, compatibility analysis, competency assessment, etc. The functionality may further include a Virtual Team tab that allows the user to create and change configuration of virtual teams.

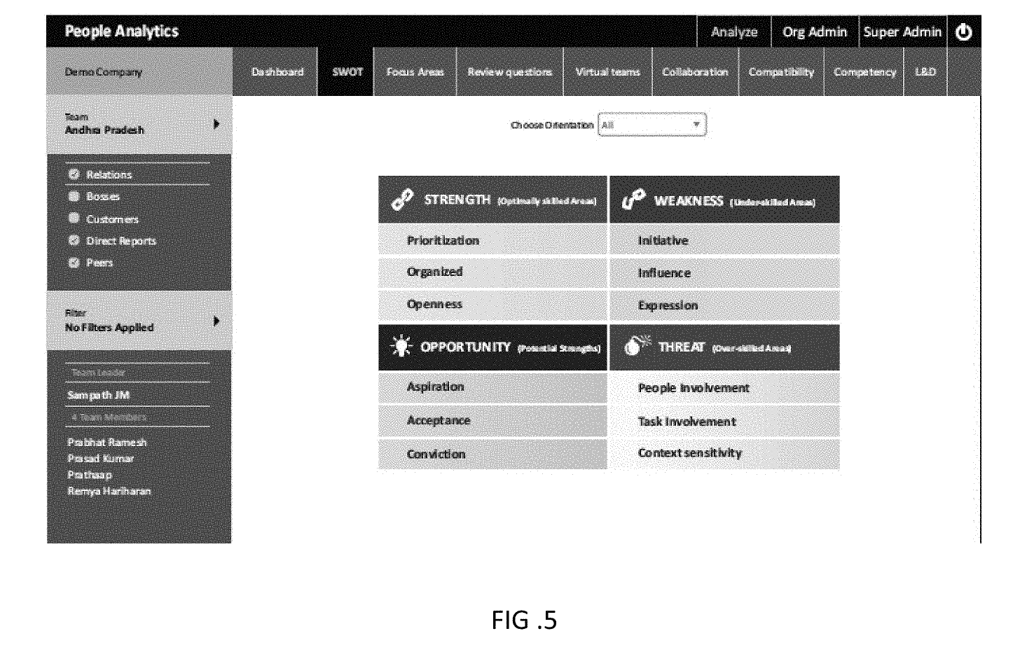

FIG. 5 is an illustrative depiction of a snapshot of the interactive dashboard interface that showcases the various character attributes of a person under a SWOT analysis. The dashboard interface depicts the strengths, weakness, opportunity and threats with respect to various character attributes and provides lessons or hyperlinks on how specific character attributes may be improved.

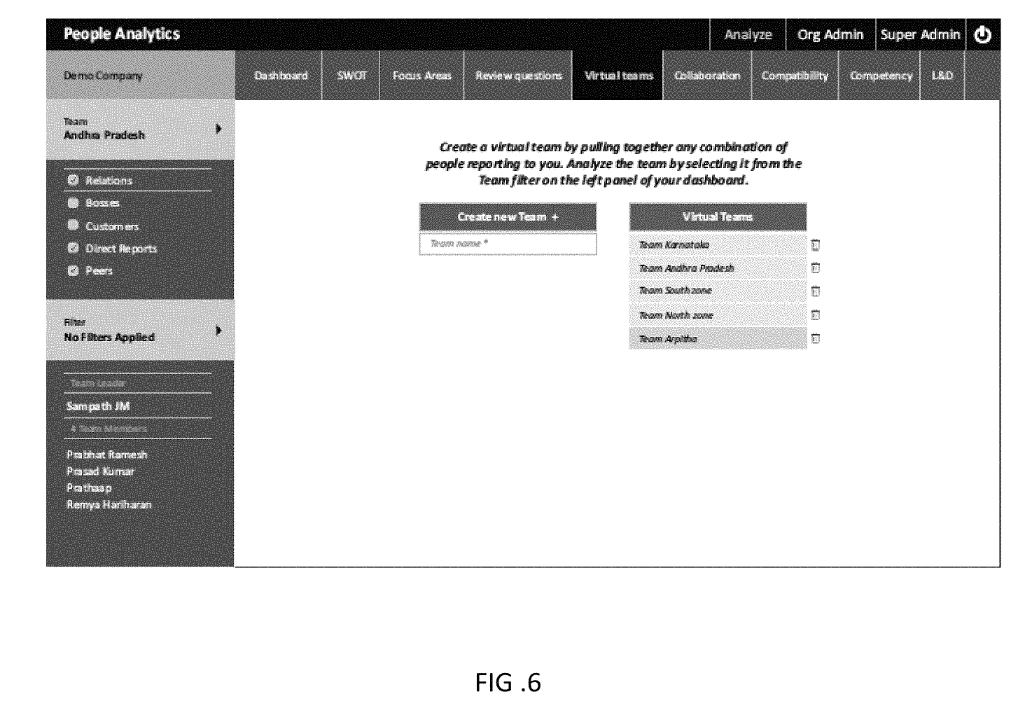

FIG. 6 is an illustrative depiction of a snapshot of the interactive dashboard interface that showcases the display of a virtual team and the option provided to a user to replace the members of the virtual team with other members or change the configuration to visualize dynamically updated competency analysis.

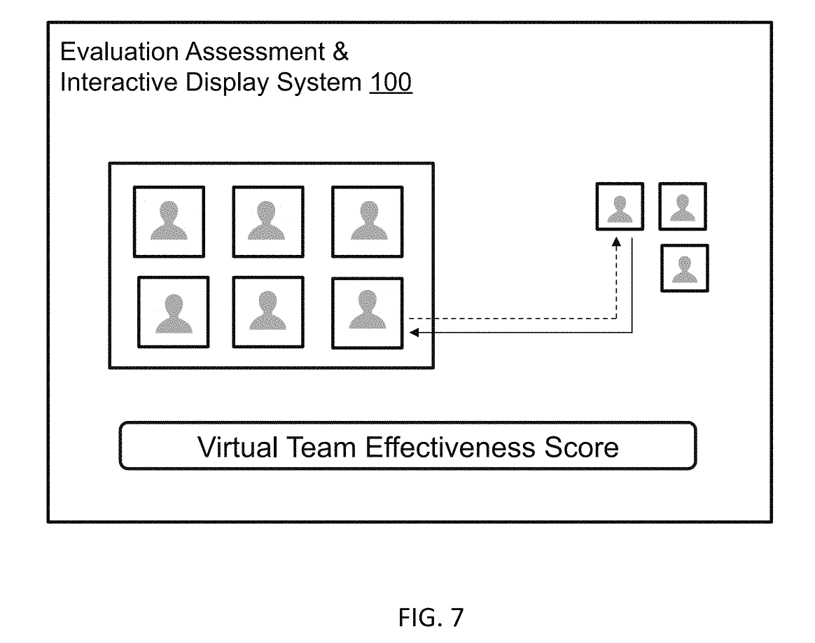

FIG. 7 is an exemplary depiction of virtual team building in the interactive dashboard interface 108. The interactive dashboard interface 108 is capable of generating virtual teams for project requirements based on the competency analysis scores of individuals. The virtual team thus generated is based on the competency analysis scores of every individual depending on the analysis as aforementioned. For example, an individual possessing a good score on the leadership parameter may be teamed up with another individual lacking at leadership qualities. Thus, the virtual team will possess the necessary parameters for the respective project delivery. The competency analysis score of this virtual team will be a cumulative result of the competency analysis scores of the individual members of the virtual team, and this score is viewed on the virtual team effectiveness score bar present in the interactive dashboard interface 108.

In an exemplary embodiment, the user may be able to tweak the virtual team to visualize the change in the competency analysis score of the virtual team. As depicted in FIG. 7, the user may drag an existing member out of the virtual team to visualize the change in the competency score. Alternatively, the user may replace an existing member of the virtual team with an individual who is not already a member to view the impact on the overall competency score and compare this score with the previous one to generate a team fit for the project.

In another exemplary embodiment, the user may also add a new individual to the generated virtual team, and view the competency score and the fitment of the new member in the virtual team.

The foregoing description of the specific embodiments will so fully reveal the general nature of the embodiments herein that others can, by applying current knowledge readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred and exemplary embodiments, those skilled in the art will recognize that the embodiments herein can be practiced with modification within the spirit and scope of the embodiments as described herein.

What is claimed is:

1. A system comprising:
a non-transitory computer readable memory, the memory storing processor readable instructions;
a processor configured to access the memory and execute the processor readable instructions wherein the processor readable instructions when executed cause the processor to
receive ratings by a first individual for multiple questions from a questionnaire based on a pre-determined self-rater;
receive from at least one peer of the first individual ratings of the first individual for the multiple questions based on a predetermined multi-rater;
compare the ratings from the first individual and the ratings from the at least one peer;
provide at least one recommendation regarding competency analysis of an at least two member virtual team, based on the self rater and the multi rater ratings of the at least two members out of which the first individual is one member;
dynamically update the competency analysis of the virtual team when the first individual is replaced by at least one other individual; and
a user device display unit configured to display an interactive dashboard interface in communication with the processor, the interactive dashboard interface configured to
showcase to a user, competency analysis of the virtual team;
allow a user to interactively modify the configuration of the virtual team to visualize the change in competency of the virtual team in near real time.

2. The system of claim 1, wherein the processor is further configured to provide at least one lesson related recommendation with hyperlink, to be automatically displayed within the interactive dashboard interface based on increasing the competency of the virtual team.

3. The system of claim 1, wherein the modification in the configuration of virtual team is chosen from a group consisting of removal of a team member, replace of a team member and addition of a new member.

4. The system of claim 1, wherein the interactive dashboard display is configured to, via interaction with the display unit's touch interface, allow the user to interactively modify the configuration of the virtual team to visualize the change in competency of the virtual team in near real time.

5. The system of claim 1, wherein the interactive dashboard display is configured to, via voice command processed by the user device, allow the user to modify the configuration of the virtual team to visualize the change in competency of the virtual team in near real time.

6. The system of claim 1, wherein the processor is further configured to automatically create at least one virtual team based on character attribute criteria listed by a user.

7. The system of claim 1, wherein the questionnaire is based on a pre-determined model, the pre-determined model comprising one or more test dimensions, each of the one or more test dimensions comprising one or more key areas, each of the one or more key areas having one or more behaviors, each of the one or more behaviors having one or more practices, each of the one or more practices being assigned a pre-determined level, wherein each question of the questionnaire is associated with a corresponding practice.

8. A method comprising:
receiving at a processor, via a network, rating by a first individual for multiple questions from a questionnaire based on a pre-determined self-rater;
receiving, at the processor, from at least one peer of the first individual ratings of the first individual for the multiple questions based on a predetermined multi-rater;
comparing, by processor, the ratings from the first individual and the ratings from the at least one peer;
providing, by the processor at least one recommendation regarding competency analysis of an at least two member virtual team, based on the self rater and the multi rater ratings of the at least two members out of which the first individual is one member;
updating dynamically the competency analysis of the virtual team when a user modifies the configuration of the virtual team; and
displaying an interactive dashboard interface, on a user device display unit in communication with the processor, the interactive dashboard interface configured to
showcasing to a user, competency analysis of the virtual team;
allowing a user to interactively modify the configuration of the virtual team to visualize the change in competency of the virtual team in near real time.

9. The method of claim 8, further comprising recommending, by the processor, at least one lesson related recommendation with hyperlink, to be automatically displayed within the interactive dashboard interface based on increasing the competency of the virtual team.

10. The method of claim 8, further comprising the modification of the virtual team by the user being chosen from a group consisting of removal of a team member, replace of a team member and addition of a new member.

11. The method of claim 8, further comprising permitting modification, by interaction with the display unit, of the virtual team configuration to visualize the change in competency of the virtual team in near real time.

12. The method of claim 8, further comprising permitting modification, via voice command processed by the user device, of the virtual team configuration to visualize the change in competency of the virtual team in near real time.

13. The method of claim 8, further comprising creating automatically at least one virtual team based on character attribute criteria listed by a user.

14. The method of claim 8, further comprising providing questions to the first individual from the questionnaire which is based on a pre-determined model, the pre-determined model comprising one or more test dimensions, each of the one or more test dimensions comprising one or more key areas, each of the one or more key areas having one or more behaviors, each of the one or more behaviors having one or more practices, each of the one or more practices being assigned a pre-determined level, wherein each question of the questionnaire is associated with a corresponding practice.
